(19) United States
(12) Patent Application Publication
(10) Pub. No.: US 2011/0207851 A1
(43) Pub. Date: Aug. 25, 2011

(54) USE OF AQUEOUS COMPOSITE-PARTICLE DISPERSIONS AS BINDERS IN ELASTIC COATINGS

(75) Inventors: Bas Lohmeijer, Mannheim (DE); Harm Wiese, Laudenbach (DE); Roland Baumstark, Neustadt (DE); Luis Carlos Santos Esteves, Mannheim (DE)

(73) Assignee: BASF SE, Ludwigshafen (DE)

(21) Appl. No.: 13/061,644

(22) PCT Filed: Sep. 1, 2009
(86) PCT No.: PCT/EP2009/061281

§ 371 Date: Mar. 1, 2011

(30) Foreign Application Priority Data
Sep. 2, 2008 (EP) 08163496.6

(51) Int. Cl. C09D 137/00; B05D 3/00

(52) U.S. Cl. 523/410; 427/386

(57) ABSTRACT

The present invention provides for the use of an aqueous dispersion of particles composed of polymer and finely divided inorganic solid (aqueous composite-particle dispersion) as a binder in elastic coatings, such as paints, more particularly exterior architectural paints, comprising preparing the aqueous composite-particle dispersion by dispersely distributing ethylenically unsaturated monomers in an aqueous medium and carrying out polymerization by means of at least one free-radical polymerization initiator in the presence of at least one dispersely distributed, finely divided inorganic solid having an average particle diameter ≦100 nm and at least one dispersant by the method of free-radically aqueous emulsion polymerization, and using as ethylenically unsaturated monomers a monomer mixture which comprises ethylenically unsaturated monomers A and optionally 0% to ≦10% by weight of an ethylenically unsaturated monomer B containing an epoxide group (epoxide monomer).

The present invention provides for the use of an aqueous dispersion of particles composed of polymer and finely divided inorganic solid (aqueous composite-particle dispersion) as a binder in elastic coatings, such as paints, more particularly exterior architectural paints, comprising preparing the aqueous composite-particle dispersion by dispersely distributing ethylenically unsaturated monomers in an aqueous medium and carrying out polymerization by means of at least one free-radical polymerization initiator in the presence of at least one dispersely distributed, finely divided inorganic solid having an average particle diameter ≦100 nm and at least one dispersant by the method of free-radically aqueous emulsion polymerization, and using as ethylenically unsaturated monomers a monomer mixture which comprises ethylenically unsaturated monomers A and optionally 0% to ≦10% by weight of an ethylenically unsaturated monomer B containing an epoxide group (epoxide monomer).

The present invention likewise provides an elastic coating material comprising the aqueous composite-particle dispersion of the invention, and also the preparation and use thereof, and also paints, more particularly exterior architectural paints, that comprise said coating material. The elastic coating materials of the invention, based on the aqueous composite-particle dispersions, are notable for improved soil pickup resistance, high water vapor permeability, and good elasticity.

Elastic coatings are characterized by a high degree of elasticity. This quality is utilized to give the elastic coatings sufficient crack-bridging capacity even at low temperatures (−10° C.). Further requirements of elastic coatings are high water resistance, good water vapor permeability, and high soil pickup resistance. The glass transition temperature of the polymer is normally adjusted by way of the monomer composition to temperatures below −10° C. Polymers with a low glass transition temperature have an increased propensity toward soil pickup. This can be prevented using crosslinking systems which make the polymer harder and more elastic (glass transition temperature is raised). State of the art, for example, is metal salt crosslinking or UV crosslinking. The subsequent addition of calcium ions results in crosslinking, as described by B. G. Bufkin and J. R. Grawe in J. Coatings Tech., 1978 50(644), 83. One possible disadvantage might be increased sensitivity to water. UV crosslinking and/or daylight crosslinking is achieved through addition of benzophenone and its derivatives, as described in U.S. Pat. No. 3,320,198, EP 100 00, EP 522 789, EP 1 147139. EP 1 845 142 describes the addition of a photoinitiator to AAEM-comprising dispersions.

Other possibilities for obtaining high elasticity and good water vapor permeability include the use of silicones, as described in U.S. Pat. No. 5,066,520, for example. The use of fluoroacrylates results in highly hydrophobic coatings which are likewise able to repel soiling (EP 890 621).

It was an object of the present invention to develop an elastic coating material having sufficient elasticity and water resistance in conjunction with high soil pickup resistance and water vapor permeability.

Coating systems featuring the aqueous composite-particle dispersions defined above as binders are notable, surprisingly, for high soil pickup resistance, owing to the hardness of the polymer film. At the same time, the water vapor permeability is positively influenced by the inorganic fractions in the dispersion.

Composite particles which are composed of polymer and finely divided inorganic solids are generally known, in particular in the form of their aqueous dispersions (aqueous composite-particle dispersions). These are fluid systems which comprise particles in disperse distribution, composed of polymer coils consisting of a plurality of interlaced polymer chains, the so-called polymer matrix, and finely divided inorganic solids present as the disperse phase in an aqueous dispersing medium. The median diameter of the composite particles is as a rule in the range of ≧10 nm and ≦1000 nm, often in the range of ≧10 nm and ≦400 nm and frequently in the range of ≧50 nm and ≦300 nm.

Composite particles and processes for their production in the form of aqueous composite-particle dispersions and the use thereof are known to the person skilled in the art and are disclosed, for example, in the publications U.S. Pat. No. 3,544,500, U.S. Pat. No. 4,421,660, U.S. Pat. No. 4,608,401, U.S. Pat. No. 4,981,882, EP-A 104 498, EP-A 505 230, EP-A 572 128, GB-A 2 227 739, WO 0118081, WO 0129106, WO 03000760 and in Long et al., Tianjin Daxue Xuebao 1991, 4, pages 10 to 15, Bourgeat-Lami et al., Die Angewandte Makromolekulare Chemie 1996, 242, pages 105 to 122, Paulke et al., Synthesis Studies of Paramagnetic Polystyrene Latex Particles in Scientific and Clinical Applications of Magnetic Carriers, pages 69 to 76, Plenum Press, New York, 1997, Armes et al, Advanced Materials 1999, 11, No. 5, pages 408 to 410.

The preparation of the aqueous composite-particle dispersions is advantageously effected by dispersing ethylenically unsaturated monomers in an aqueous medium and polymerizing them by means of at least one free radical polymerization initiator in the presence of at least one dispersed, finely divided inorganic solid and at least one dispersant by the free radical aqueous emulsion polymerization method.

According to the invention, it is possible to use all aqueous composite-particle dispersions, for example including those obtainable according to the above-mentioned prior art, which were prepared using a monomer mixture which comprises >0 and ≦10% by weight, preferably from 0.1 to 5% by weight and particularly preferably from 0.5 to 3% by weight of epoxide monomers. Such aqueous composite-particle dispersions and processes for their preparation are disclosed in EP 1838 740, which is hereby incorporated by reference in this patent application.

According to the invention, those aqueous composite-particle dispersions which were prepared using the monomer mixture comprising epoxide monomers by the procedure disclosed in WO 03000760 can advantageously be used. This process disclosed in WO 03000760 is distinguished in that the monomer mixture is dispersed in an aqueous medium and polymerized by means of at least one free radical polymerization initiator in the presence of at least one dispersed, finely divided inorganic solid and at least one dispersant by the free radical aqueous emulsion polymerization method,
a) a stable aqueous dispersion of the at least one inorganic solid being used, wherein said dispersion, at an initial solids concentration of ≧1% by weight, based on the aqueous dispersion of the at least one inorganic solid, still comprises more than 90% by weight of the originally dispersed solid in dispersed form one hour after its preparation, and the dispersed solid particles thereof have a median diameter of ≧100 nm,
b) the dispersed solid particles of the at least one inorganic solid exhibiting an electrophoretic mobility differing from zero in an aqueous standard potassium chloride solution at a pH which corresponds to the pH of the aqueous dispersing medium before the beginning of the addition of the dispersant,
c) at least one anionic, cationic and nonionic dispersant being added to the aqueous solid particle dispersion before the beginning of the addition of the monomer mixture,
d) from 0.01 to 30% by weight of the total amount of monomer mixture then being added to the aqueous solid particle dispersion and being polymerized to a conversion of at least 90%
   and
e) thereafter the remaining amount of the monomer mixture being added continuously under polymerization conditions at the rate of consumption.

All those finely divided inorganic solids which form stable aqueous dispersions which, at an initial solids concentration of ≧1% by weight, based on the aqueous dispersion of the at least one inorganic solid, still comprise more than 90% by weight of the originally dispersed solid in dispersed form one hour after their preparation without stirring or shaking and the dispersed solid particles thereof have a median diameter of ≦100 nm and moreover exhibit an electrophoretic mobility differing from zero at a pH which corresponds to the pH of the aqueous reaction medium before the beginning of the addition of the dispersant are suitable for this process.

The quantitative determination of the initial solids concentration and of the solids concentration after one hour and the determination of the median particle diameter are effected by the analytical ultracentrifuge method (cf. in this context S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). The values stated in the case of the particle diameter correspond to the so-called d₅₀-values.

The method for the determination of the electrophoretic mobility is known to the person skilled in the art (cf. for example B. R. J. Hunter, Introduction to modern Colloid Science, chapter 8.4, pages 241 to 248, Oxford University Press, Oxford, 1993 and K. Oka and K. Furusawa, in Electrical Phenomena at Interfaces, Surfactant Science Series, vol. 76, chapter 8, pages 151 to 232, Marcel Dekker, New York, 1998). The electrophoretic mobility of the solid particles dispersed in the aqueous reaction medium is determined by means of a commercial electrophoresis apparatus, such as, for example, the Zetasizer 3000 from Malvern Instruments Ltd., at 20° C. and atmospheric pressure (1 atm=1.013 bar). For this purpose, the aqueous solid particle dispersion is diluted with a pH-neutral 10 millimolar (mM) aqueous potassium chloride solution (standard potassium chloride solution) until the solid particle concentration is about 50 to 100 mg/l. The adjustment of the measured sample to the pH which the aqueous reaction medium has before the beginning of the addition of the dispersants is effected by means of the customary inorganic acids, such as, for example, dilute hydrochloric acid or nitric acid, or bases, such as, for example, dilute sodium hydroxide solution or potassium hydroxide solution. The migration of the dispersed solid particles in the electric field is detected by means of so-called electrophoretic light scattering (cf. for example B. R. Ware and W. H. Flygare, Chem. Phys. Lett. 1971, 12, pages 81 to 85). The sign of the electrophoretic mobility is defined by the migration direction of the dispersed solid particles, i.e. if the dispersed solid particles migrate to the cathode, their electrophoretic mobility is positive, and if on the other hand they migrate to the anode, it is negative.

A suitable parameter for influencing or adjusting the electrophoretic mobility of dispersed solid particles in a certain range is the pH of the aqueous reaction medium. By protonation or deprotonation of the dispersed solid particles, the electrophoretic mobility is changed in the positive direction in the acidic pH range (pH<7) and in the negative direction in the alkaline range (pH>7). The pH range suitable for the process disclosed in WO 03000760 is that within which a free radically initiated aqueous emulsion polymerization can be carried out. This pH range is as a rule from pH 1 to 12, frequently from pH 1.5 to 11 and often from pH 2 to 10.

The pH of the aqueous reaction medium can be adjusted by means of commercial acids, such as, for example, dilute hydrochloric, nitric or sulfuric acid, or bases, such as, for example, dilute sodium hydroxide or potassium hydroxide solution. It is frequently advantageous if a portion or the total amount of the acid or base used for the pH adjustment is added to the aqueous reaction medium before the at least one finely divided inorganic solid.

It is advantageous to the process disclosed according to WO 03000760 that, based on 100 parts by weight of monomer mixture, advantageously from 1 to 1000 parts by weight of the finely divided inorganic solid are used and, under the abovementioned pH conditions, when the dispersed solid particles
have an electrophoretic mobility with a negative sign, from 0.01 to 10 parts by weight, preferably from 0.05 to 5 parts by weight and particularly preferably from 0.1 to 3 parts by weight of at least one cationic dispersant, from 0.01 to 100 parts by weight, preferably from 0.05 to 50 parts by weight and particularly preferably from 0.1 to 20 parts by weight of at least one nonionic dispersant and at least one anionic dispersant are used, the amount thereof being such that the equivalent ratio of anionic to cationic dispersant is greater than 1, or
have an electrophoretic mobility with a positive sign, from 0.01 to 10 parts by weight, preferably from 0.05 to 5 parts by weight and particularly preferably from 0.1 to 3 parts by weight of at least one anionic dispersant, from 0.01 to 100 parts by weight, preferably from 0.05 to 50 parts by weight and particularly preferably from 0.1 to 20 parts by weight of at least one nonionic dispersant and at least one cationic dispersant are used, the amount thereof being such that the equivalent ratio of cationic to anionic dispersant is greater than 1.

Equivalent ratio of anionic to cationic dispersant is understood as meaning the ratio of the number of moles of anionic dispersant used multiplied by the number of anionic groups present per mole of the anionic dispersant, divided by the number of moles of the cationic dispersant used, multiplied by the number of cationic groups present per mole of the cationic dispersant. The same applies to the equivalent ratio of cationic to anionic dispersant.

The total amount of the at least one anionic, cationic or nonionic dispersant used according to WO 03000760 can be initially taken in the aqueous solid dispersion. However, it is also possible initially to take only a portion of said dispersants in the aqueous solid dispersion and to add the remaining amounts continuously or batchwise during the free radical emulsion polymerization. What is essential for the process, however, is that the abovementioned equivalent ratio of anionic and cationic dispersant be maintained as a function of the electrophoretic sign of the finely divided solid before and during free radical emulsion polymerization. If, therefore, inorganic solid particles which have an electrophoretic mobility with a negative sign under the above-mentioned pH conditions are used, the equivalent ratio of anionic to cationic dispersant must be greater than 1 during the entire emulsion polymerization. In a corresponding manner, the equivalent ratio of cationic to anionic dispersant must be greater than 1 during the entire emulsion polymerization in the case of inorganic solid particles having an electrophoretic mobility with a positive sign. It is advantageous if the equivalent ratios are ≧2, ≧3, ≧4, ≧5, ≧6, ≧7, or ≧10, the equivalent ratios in the range from 2 to 5 being particularly advantageous.

Metals, metal compounds, such as metal oxides and metal salts, but also semi-metal and non-metal compounds, are suitable for the process disclosed in WO 03000760 and generally finely divided inorganic solids which can be used for the preparation of aqueous composite-particle dispersions. Finely divided metal powders which may be used are noble metal colloids, such as, for example, palladium, silver, ruthenium, platinum, gold and rhodium, and alloys comprising these. Finely divided metal oxides which may be mentioned by way of example are titanium dioxide (for example commercially available as Hombitec® brands from Sachtleben Chemie GmbH), zirconium(IV) oxide, tin(II) oxide, tin(IV) oxide (for example commercially available as Nyacol® SN brands from Nyacol Nano Technologies, Inc.), alumina (for example commercially available as Nyacol® AL brands from Nyacol Nano Technologies, Inc.), barium oxide, magnesium oxide, various iron oxides, such as iron(II) oxide (wuestite), iron(III) oxide (hematite) and iron(II/III) oxide (magnetite), chromium(III) oxide, antimony(III) oxide, bismuth(III) oxide, zinc oxide (for example commercially available as Sachtotec® brands from Sachtleben Chemie GmbH), nickel(II) oxide, nickel(III) oxide, cobalt(II) oxide, cobalt(III) oxide, copper(II) oxide, yttrium(III) oxide (for example commercially available as Nyacol® YTTRIA brands from Nyacol Nano Technologies, Inc.), cerium(IV) oxide (for example commercially available as Nyacol® CEO2 brands from Nyacol Nano Technologies, Inc.) in amorphous form and/or in their different crystal modifications and hydroxyoxides thereof, such as, for example, hydroxytitanium(IV) oxide, hydroxyzirconium(IV) oxide, hydroxyaluminum oxide (for example commercially available as Disperal® brands from Sasol Germany GmbH) and hydroxyiron(III) oxide, in amorphous form and/or in their different crystal modifications. The following metal salts present in amorphous form and/or in their different crystal structures can in principle be used in the method according to the invention: sulfides, such as iron(II) sulfide, iron(III) sulfide, iron(II) disulfide (pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, bismuth(III) sulfide, hydroxides, such as tin(II) hydroxide, aluminum hydroxide, magnesium hydroxide, calcium hydroxide, barium hydroxide, zinc hydroxide, iron(II) hydroxide, iron(III) hydroxide, sulfates, such as calcium sulfate, strontium sulfate, barium sulfate, lead(IV) sulfate, carbonates, such as lithium carbonate, magnesium carbonate, calcium carbonate, zinc carbonate, zirconium(IV) carbonate, iron(II) carbonate, iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, iron(III) orthophosphate, metaphosphates, such as lithium metaphosphate, calcium metaphosphate, aluminum metaphosphate, pyrophosphates, such as magnesium pyrophosphate, calcium pyrophosphate, zinc pyrophosphate, iron(III) pyrophosphate, tin(II) pyrophosphate, ammonium phosphates, such as magnesium ammonium phosphate, zinc ammonium phosphate, hydroxylapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, sheet silicates, such as sodium aluminum silicate and sodium magnesium silicate, in particular in spontaneously delaminating form, such as, for example, Optigel® SH (brand of Südchemie AG), Laponite® RD and Laponite® GS (brands of Rockwood Specialties Inc.), aluminates, such as lithium aluminate, calcium aluminate, zinc aluminate, borates, such as magnesium metaborate, magnesium orthoborate, oxalates, such as calcium oxalate, zirconium(IV) oxalate, magnesium oxalate, zinc oxalate, aluminum oxalate, tartrates, such as calcium tartrate, acetylacetonates, such as aluminum acetylacetonate, iron(III) acetylacetonate, salicylates, such as aluminum salicylate, citrates, such as calcium citrate, iron(II) citrate, zinc citrate, palmitates, such as aluminum palmitate, calcium palmitate, magnesium palmitate, stearates, such as aluminum stearate, calcium stearate, magnesium stearate, zinc stearate, laurates, such as calcium laurate, linoleates, such as calcium linoleate, oleates, such as calcium oleate, iron(II) oleate or zinc oleate.

Silica present in amorphous form and/or in different crystal structures may be mentioned as a substantial semimetal compound which can be used according to the invention. Silica suitable according to the invention is commercially available and can be obtained, for example, as Aerosil® (brand of Evonik Industries AG), Levasil® (brand of HC Starck GmbH), Ludox® (brand of DuPont), Nyacol® (brand of Nyacol Nano Technologies, Inc.) and Bindzil® (brands of Eka Chemicals) and Snowtex® (brand of Nissan Chemical Industries, Ltd.). Nonmetal compounds suitable according to the invention are, for example, colloidal graphite or diamond.

Particularly suitable finely divided inorganic solids are those whose solubility in water at 20° C. and atmospheric pressure is ≦1 g/l, preferably ≦0.1 g/l and in particular ≦0.01 g/l. Compounds selected from the group consisting of silica, alumina, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium pyrophosphate, magnesium pyrophosphate, orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, sheet silicates, such as sodium aluminum silicate and sodium magnesium silicate, in particular in spontaneously delaminating form, such as, for example, Optigel® SH, Saponit®, Laponite® RD and Laponite® GS, iron(II) oxide, iron(III) oxide, iron(II/III) oxide, titanium dioxide, hydroxylapatite, zinc oxide and zinc sulfide are particularly preferred.

The at least one finely divided inorganic solid is preferably selected from the group consisting of silica, alumina, hydroxyaluminum oxide, calcium carbonate, magnesium carbonate, calcium orthophosphate, magnesium orthophosphate, iron(II) oxide, iron(III) oxide, iron(II/III) oxide, tin(IV) oxide, cerium(IV) oxide, yttrium(III) oxide, titanium dioxide, hydroxylapatite, zinc oxide and zinc sulfide.

Silicon-containing compounds, such as pyrogenic and/or colloidal silica, silica sols and/or sheet silicates, are particularly preferred. These silicon-containing compounds preferably have an electrophoretic mobility with a negative sign.

The commercially available compounds of the Aerosil®, Levasil®, Ludox®, Nyacol® and Bindzil® brands (silica), Disperal® brands (hydroxyaluminum oxide), Nyacol® AL brands (alumina), Hombitec® brands (titanium dioxide), Nyacol® SN brands (tin(IV) oxide), Nyacol® YTTRIA brands (yttrium(III) oxide), Nyacol® CEO2 brands (cerium(IV) oxide) and Sachtotec® brands (zinc oxide) can also advantageously be used in the method according to the invention.

The finely divided inorganic solids which can be used for the production of the composite particles are such that the solid particles dispersed in the aqueous reaction medium have a median particle diameter of ≦100 nm. Those finely divided inorganic solids whose dispersed particles have a median particle diameter of >0 nm but ≦90 nm, ≦80 nm, ≦70 nm, ≦60 nm, ≦50 nm, ≦40 nm, ≦30 nm, ≦20 nm or ≦10 nm and all values in between are successfully used. Advantageously used finely divided inorganic solids are those which have a particle diameter of ≦60 nm. The particle diameter is determined by the analytical ultracentrifuge method.

The accessibility of finely divided solids is known in principle to the person skilled in the art and is effective, for example, by precipitation reactions or chemical reactions in the gas phase (cf. in this context E. Matijevic, Chem. Mater. 1993, 5, pages 412 to 426; Ullmann's Encyclopedia of Industrial Chemistry, vol. A 23, pages 583 to 660, Verlag Chemie, Weinheim, 1992; D. F. Evans, H. Wennerström in The Colloidal Domain, pages 363 to 405, Verlag Chemie, Weinheim, 1994 and R. J. Hunter in Foundations of Colloid Science, vol. I, pages 10 to 17, Clarendon Press, Oxford, 1991).

The preparation of the stable solids dispersion is frequently effected directly in the synthesis of the finely divided inorganic solids in an aqueous medium or alternatively by dispersing the finely divided inorganic solid in the aqueous medium. Depending on the route of preparation of the finely divided inorganic solids, this is possible either directly, for example in the case of precipitated or pyrogenic silica, alumina, etc., or with the aid of suitable auxiliary units, such as, for example, dispersers or ultrasonic sonotrodes.

Those finely divided inorganic solids whose aqueous solids dispersion, at an initial solids concentration of ≧1% by weight, based on the aqueous dispersion of the finely divided inorganic solid, still comprises more than 90% by weight of the originally dispersed solid in dispersed form one hour after its preparation or by stirring up or shaking up the sedimented solids, without further stirring or shaking, and the dispersed solid particles thereof have a diameter of ≦100 nm are advantageously suitable for the preparation of the aqueous composite-particle dispersions. Initial solids concentrations of ≦60% by weight are usual. However, initial solids concentrations of ≦55% by weight, ≦50% by weight, ≦45% by weight, ≦40% by weight, ≦35% by weight, ≦30% by weight, ≦25% by weight, ≦20% by weight, ≦15% by weight, ≦10% by weight, and ≧2% by weight, ≧3% by weight, ≧4% by weight or ≧5% by weight and all values in between, based in each case on the aqueous dispersion of the finely divided inorganic solid, can also advantageously be used. In the preparation of aqueous composite-particle dispersions, frequently from 1 to 1000 parts by weight, as a rule from 5 to 300 parts by weight and often from 10 to 200 parts by weight of the at least one finely divided inorganic solid, based on 100 parts by weight of a monomer mixture, are used. Advantageously from 10 to 50 parts by weight and particularly advantageously from 25 to 40 parts by weight of the at least one finely divided inorganic solid, based on 100 parts by weight of a monomer mixture, are used.

In the preparation of the aqueous composite-particle dispersions, dispersants which keep both the finely divided inorganic solid particles and the monomer droplets and the composite particles formed in dispersion in the aqueous phase and thus ensure the stability of the aqueous composite-particle dispersions produced are generally concomitantly used. Suitable dispersants are both the protective colloids usually used for carrying out free radical aqueous emulsion polymerizations and emulsifiers.

A detailed description of suitable protective colloids is to be found in Houben-Weyl, Methoden der organischen Chemie, volume XIV/1, Makromolekulare Stoffe, Georg-Thieme-Verlag, Stuttgart, 1961, pages 411 to 420.

Suitable neutral protective colloids are, for example, polyvinyl alcohols, polyalkylene glycols, and cellulose, starch and gelatin derivatives.

Suitable anionic protective colloids, i.e. protective colloids whose component having a dispersing effect has at least one negative electrical charge, are, for example, polyacrylic acids and polymethacrylic acids and alkali metal salts thereof, copolymers comprising acrylic acid, methacrylic acid, 2-acrylamido-2-methylpropanesulfonic acid, 4-styrenesulfonic acid and/or maleic anhydride, and alkali metal salts thereof, and alkali metal salts of sulfonic acids of high molecular weight compounds, such as, for example, polystyrene.

Suitable cationic protective colloids, i.e. protective colloids whose component having a dispersing effect has at least one positive electrical charge, are, for example, those derivatives of N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide and homo- and copolymers comprising amino group-carrying acrylates, methacrylates, acrylamides and/or methacrylamides which are protonated and/or alkylated on the nitrogen.

Of course, it is also possible to use mixtures of emulsifiers and/or protective colloids. Frequently, exclusively emulsifiers whose relative molecular weights, in contrast to the protective colloids, are usually below 1500 are used as dispersants. In the case of the use of mixtures of surface-active substances, the individual components must of course be compatible with one another, which, in case of doubt, can be checked by means of a few preliminary experiments. An overview of suitable emulsifiers is to be found in Houben-Weyl, Methoden der organischen Chemie, volume XIV/1, Makromolekulare Stoffe, Georg-Thieme-Verlag, Stuttgart, 1961, pages 192 to 208.

Customary nonionic emulsifiers are, for example, ethoxylated mono-, di- and trialkylphenols (degree of ethoxylation: 3 to 50, alkyl radical: C₄ to C₁₂) and ethoxylated fatty alcohols (degree of ethoxylation: 3 to 80; alkyl radical: C₈ to C₃₆). Examples of these are the Lutensol® A brands (C₁₂C₁₄-fatty alcohol ethoxylates, degree of ethoxylation: 3 to 8), Lutensol® AO brands (C₁₃C₁₅-oxo alcohol ethoxylates, degree of ethoxylation: 3 to 30), Lutensol® AT brands (C₁₆C₁₈-fatty alcohol ethoxylates, degree of ethoxylation: 11 to 80), Lutensol® ON brands (C₁₀-oxo alcohol ethoxylates, degree of ethoxylation: 3 to 11) and the Lutensol® TO brands (C₁₃-oxo alcohol ethoxylates, degree of ethoxylation: 3 to 20) from BASF AG.

Customary anionic emulsifiers are, for example, alkali metal and ammonium salts of alkyl sulfates (alkyl radical: C₈ to C₁₂), of sulfuric monoesters of ethoxylated alkanols (degree of ethoxylation: 4 to 30, alkyl radical: C₁₂ to C₁₈) and of ethoxylated alkylphenols (degree of ethoxylation: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈).

Furthermore, compounds of the general formula I

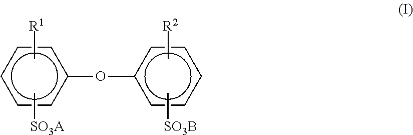

where R¹ and R² are H atoms or C₄- to C₂₄-alkyl and are not simultaneously H atoms, and A and B may be alkali metal ions and/or ammonium ions, have proven suitable as further anionic emulsifiers. In the general formula I, R¹ and R² are preferably linear or branched alkyl radicals having 6 to 18 carbon atoms, in particular having 6, 12 and 16 carbon atoms, or —H, R¹ and R² not both simultaneously being H atoms. A and B are preferably sodium, potassium or ammonium, sodium being particularly preferred. Compounds I in which A and B are sodium, R′ is a branched alkyl radical having 12 carbon atoms and R² is an H atom or R¹ are particularly advantageous. Industrial mixtures which have a proportion of from 50 to 90% by weight of the monoalkylated product, such as, for example, Dowfax® 2A1 (brand of Dow Chemical Company), are frequently used. The compounds I are generally known, for example from U.S. Pat. No. 4,269,749, and are commercially available.

Suitable cationic emulsifiers are as a rule primary, secondary, tertiary or quaternary ammonium salts, alkanolammonium salts, pyridinium salts, imidazolinium salts, oxazolinium salts, morpholinium salts, thiazolinium salts having a C₆- to C₁₈-alkyl, C₆- to C₁₈-aralkyl or heterocyclic radical and salts of amine oxides, quinolinium salts, isoquinolinium salts, tropylium salts, sulfonium salts and phosphonium salts. Dodecylammonium acetate or the corresponding hydrochloride, the chlorides or acetates of the various 2-(N,N,N-trimethylammonium)ethylparaffin acid esters, N-cetylpyridinium chloride, N-laurylpyridinium sulfate and N-cetyl-N,N,N-trimethylammonium bromide, N-dodecyl-N,N,N-trimethylammonium bromide, N-octyl-N,N,N-trimethlyammonium bromide, N,N-distearyl-N,N-dimethylammonium chloride and the Gemini surfactant N,N′-(lauryldimethyl)ethylenediamine dibromide may be mentioned by way of example. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

From 0.1 to 10% by weight, often from 0.5 to 7.0% by weight and frequently from 1.0 to 5.0% by weight of dispersant, based in each case on the total amount of aqueous composite-particle dispersion, are frequently used for the preparation of the aqueous composite-particle dispersions. Emulsifiers, in particular nonionic and/or anionic emulsifiers, are preferably used. In the process disclosed in WO 03000760, anionic, cationic and nonionic emulsifiers are used as dispersants.

It is essential to the invention that a monomer mixture which consists of ethylenically unsaturated monomers A and >0 and ≦10% by weight of at least one ethylenically unsaturated monomer B having an epoxide group (epoxide monomer) is used for the preparation of the aqueous composite-particle dispersion which can be used according to the invention.

Suitable monomers A are, inter alia, in particular ethylenically unsaturated monomers which can be subjected to free radical polymerization in a simple manner, such as, for example, ethylene, vinylaromatic monomers, such as styrene, α-methylstyrene, o-chlorostyrene or vinyltoluenes, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids preferably having 3 to 6 carbon atoms, such as, in particular, acrylic acid, methacrylic acid, maleic acid, fumaric acid and itaconic acid, alkanols having in general 1 to 12, preferably 1 to 8 and in particular 1 to 4 carbon atoms, such as, in particular methyl, ethyl, n-butyl, isobutyl and 2-ethylhexyl acrylate and methacrylate, dimethyl maleate or di-n-butyl maleate, nitriles of α,β-monoethylenically unsaturated carboxylic acids, such as acrylonitrile, and C₄₋₈-conjugated dienes, such as 1,3-butadiene and isoprene. Said monomers form as a rule the main monomers, which together usually account for a proportion of ≧50% by weight, ≧80% by weight, or ≧90% by weight, based on the total amount of the monomers A to be polymerized by the process according to the invention. As a rule, these monomers have only a moderate to low solubility in water under standard conditions (20° C., atmospheric pressure).

Further monomers A which usually increase the internal strength of the films of the polymer matrix usually have at least one hydroxyl, N-methylol or carbonyl group or at least two non-conjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two non-conjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are the C₁-C₈-hydroxyalkyl methacrylates and acrylates, such as n-hydroxyethyl, n-hydroxypropyl or n-hydroxybutyl acrylate and methacrylate, and compounds such as diacetoneacrylamide and acetylacetoxyethyl acrylate or methacrylate. According to the invention, the abovementioned monomers are used for the polymerization in amounts of up to 5% by weight, in particular from 0.1 to 3% by weight and preferably from 0.5 to 2% by weight, based on the total amount of the monomers A to be polymerized.

Ethylenically unsaturated monomers comprising siloxane groups, such as the vinyltrialkoxysilanes, for example vinyltrimethoxysilane, alkylvinyldialkoxysilanes, acryloyloxyalkyltrialkoxysilanes, or methacryloyloxyalkyltrialkoxysilanes, such as, for example, acryloyloxyethyltrimethoxysilane, methacryloyloxyethyltrimethoxysilane, acryloyloxypropyltrimethoxysilane or methacryloyloxypropyltrimethoxysilane, can also be used as monomers A. These monomers are used in total amounts of up to 5% by weight, frequently from 0.01 to 3% by weight and more often from 0.05 to 1% by weight, based in each case on the total amount of the monomers A. According to the invention, monomers A comprising abovementioned siloxane groups are advantageously used in total amounts of from 0.01 to 5% by weight, in particular from 0.01 to 3% by weight and preferably from 0.05 to 1% by weight, based in each case on the total amount of the monomers A to be polymerized. It is important that the ethylenically unsaturated monomers comprising abovementioned siloxane groups can be metered before, simultaneously with or after the other monomers A.

Those ethylenically unsaturated monomers AS which comprise either at least one acid group and/or the corresponding anion thereof or those ethylenically unsaturated monomers AN which comprise at least one amino, amido, ureido or N-heterocyclic group and/or the ammonium derivatives thereof protonated or alkylated on the nitrogen can additionally be used as monomers A. The amount of monomers AS or monomers AN is up to 10% by weight, often from 0.1 to 7% by weight and frequently from 0.2 to 5% by weight, based on the total amount of the monomers A to be polymerized.

Ethylenically unsaturated monomers having at least one acid group are used as monomers AS. The acid group may be, for example, a carboxyl, sulfo, sulfuric acid, phosphoric acid and/or phosphonic acid group. Examples of such monomers AS are acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid, and phosphoric acid monoesters of n-hydroxyalkyl acrylates and n-hydroxyalkyl methacrylates, such as, for example, phosphoric acid monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate. According to the invention, however, it is also possible to use the ammonium and alkali metal salts of the abovementioned ethylenically unsaturated monomers having at least one acid group. Sodium and potassium are particularly preferred as the alkali metal. Examples of these are the ammonium, sodium and potassium salts of acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid and the mono- and diammonium, mono- and disodium and mono- and dipotassium salts of the phosphoric acid monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid are preferably used as monomers AS.

Ethylenically unsaturated monomers which comprise at least one amino, amido, ureido or N-heterocyclic group and/or the ammonium derivatives thereof protonated or alkylated on the nitrogen are used as monomers AN.

Examples of monomers AN which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (for example commercially available as Norsocryl® TBAEMA from Arkema), 2-(N,N-dimethylamino)ethyl acrylate (for example commercially available as Norsocryl® ADAME from Arkema), 2-(N,N-dimethylamino)ethyl methacrylate (for example, commercially available as Norsocryl® MADAME from Arkema), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-diisopropylamino)propyl acrylate and 3-(N,N-diisopropylamino)propyl methacrylate.

Examples of monomers AN which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropylmethacrylamide, N,N-di-n-butylacrylamide, N,N-di-n-butylmethacrylamide, N-(3-N′,N′-dimethylaminopropyl)methacrylamide, diacetoneacrylamide, N,N′-methylenebisacrylamide, N-(diphenylmethyl)acrylamide and N-cyclohexylacrylamide, but also N-vinylpyrrolidone and N-vinylcaprolactam.

Examples of monomers AN which comprise at least one ureido group are N,N′-divinylethyleneurea and 2-(1-imidazolin-2-onyl)ethyl methacrylate (for example commercially available as Norsocryl® 100 from Arkema).

Examples of monomers AN which comprise at least one N-heterocyclic group are 2-vinylpyridine, 4-vinylpyridine, 1-vinylimidazole, 2-vinylimidazole and N-vinylcarbazole.

The following compounds are preferably used as monomers AN: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N″,N″-dimethylaminopropyl)methacrylamide and 2-(1-imidazolin-2-onyl)ethyl methacrylate. Depending on the pH of the aqueous reaction medium, a part or the total amount of the abovementioned nitrogen-containing monomers AN may be present in the quaternary ammonium form protonated on the nitrogen.

2-(N,N,N-Trimethylammonium)ethyl acrylate chloride, (for example commercially available as Norsocryl® ADAMQUAT MC 80 from Arkema), 2-(N,N,N-trimethylammonium)ethyl methacrylate chloride (for example commercially available as Norsocryl® MADQUAT MC 75 from Arkema), 2-(N-methyl-N,N-diethylammonium)ethyl acrylate chloride, 2-(N-methyl-N,N-diethylammonium)ethyl methacrylate chloride, 2-(N-methyl-N,N-dipropylammonium)ethyl acrylate chloride, 2-(N-methyl-N,N-dipropylammonium)ethyl methacrylate, 2-(N-benzyl-N,N-dimethylammonium)ethyl acrylate chloride (for example commercially available as Norsocryl® ADAMQUAT BZ 80 from Arkema), 2-(N-benzyl-N,N-dimethylammonium)ethyl methacrylate chloride (for example commercially available as Norsocryl® MADQUAT BZ 75 from Elf Atochem), 2-(N-benzyl-N,N-diethylammonium)ethyl acrylate chloride, 2-(N-benzyl-N,N-diethylammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethylammonium)propyl acrylate chloride, 3-(N,N,N-trimethylammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)propyl acrylate chloride, 3-(N-methyl-N,N-dipropylammonium)propyl methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethylammonium)propyl acrylate chloride, 3-(N-benzyl-N,N-diethylammonium)propyl methacrylate chloride, 3-(N-benzyl-N,N-dipropylammonium)propyl acrylate chloride and 3-(N-benzyl-N,N-dipropylammonium)propyl methacrylate chloride may be mentioned by way of example as monomers AN which have a quaternary alkylammonium structure on the nitrogen. Of course, the corresponding bromides and sulfates may also be used instead of said chlorides.

2-(N,N,N-Trimethylammonium)ethyl acrylate chloride, 2-(N,N,N-trimethylammonium)ethyl methacrylate chloride, 2-(N-benzyl-N,N-dimethylammonium)ethyl acrylate chloride and 2-(N-benzyl-N,N-dimethylammonium)ethyl methacrylate chloride are preferably used.

It is of course also possible to use mixtures of the abovementioned ethylenically unsaturated monomers AS or AN.

What is important is that, in the case of WO 03000760, a portion or the total amount of the at least one anionic dispersant can be replaced by the equivalent amount of at least one monomer AS when dispersed solid particles having an electrophoretic mobility with a negative sign are present, and a portion or the total amount of the at least one cationic dispersant can be replaced by the equivalent amount of at least one monomer AN when dispersed solid particles having an electrophoretic mobility with a positive sign are present.

Particularly advantageously, the composition of the monomers A is chosen so that, after polymerization of them alone, a polymer whose glass transition temperature is ≦100° C., preferably ≦60° C., in particular ≦20° C. and frequently ≧−60° C. and often ≧−50° C. or ≧−30° C. would result.

Usually, the determination of the glass transition temperature is effected according to DIN 53 765 (differential scanning calorimetry, 20 K/min, midpoint measurement).

According to Fox (T. G. Fox, Bull. Am. Phys. Soc. 1956 [Ser. II] 1, page 123 and according to Ullmann's Encyclopädie der technischen Chemie, vol. 19, page 18, 4th edition, Verlag Chemie, Weinheim, 1980) the following is a good approximation for the glass transition temperature T_{g} of at most weakly crosslinked copolymers:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², T_{g}ⁿ are the glass transition temperatures of the polymers composed in each case only of one of the monomers 1, 2, . . . n, in degrees Kelvin. The T_{g} values for the homopolymers of most monomers are known and are stated, for example, in Ullmann's Encyclopedia of Industrial Chemistry, 5th edition, vol. A21, page 169, Verlag Chemie, Weinheim, 1992; further sources of glass transition temperatures of homopolymers are, for example, J. Brandrup, E. H. Immergut, Polymer Handbook, 1^{st} Ed., J. Wiley, New York, 1966; 2^{nd} Ed. J. Wiley, New York, 1975 and 3^{rd} Ed. J. Wiley, New York, 1989.

All ethylenically unsaturated compounds which have at least one epoxide group can be used as monomer B (epoxide monomer). In particular, however, the at least one epoxide monomer is selected from the group consisting of 1,2-epoxy-3-butene, 1,2-epoxy-3-methyl-3-butene, glycidyl acrylate (2,3-epoxypropyl acrylate), glycidyl methacrylate (2,3-epoxypropyl methacrylate), 2,3-epoxybutyl acrylate, 2,3-epoxybutyl methacrylate, 3,4-epoxybutyl acrylate and 3,4-epoxybutyl methacrylate and the corresponding alkoxylated, in particular ethoxylated and/or propoxylated glycidyl acrylates and glycidyl methacrylates, as disclosed, for example, in U.S. Pat. No. 5,763,629. According to the invention, it is of course also possible to use mixtures of epoxide monomers. Glycidyl acrylate and/or glycidyl methacrylate are preferably used as epoxide monomers.

Based on the total amount of monomers, the amount of epoxide monomer is >0 and ≧10% by weight. Frequently, the total amount of epoxide monomer is ≧0.01% by weight, ≧0.1% by weight or ≧0.5% by weight, often ≧0.8% by weight, ≧1% by weight or ≧1.5% by weight, or ≦8% by weight, ≦7% by weight or ≦6% by weight and often ≦5% by weight, ≦4% by weight or ≦3% by weight, based in each case on the total amount of monomers. The amount of epoxide monomers is preferably ≧0.1 and ≦5% by weight and particularly preferably ≧0.5 and ≦3% by weight, based in each case on the total amount of monomers.

Accordingly, the monomer mixture to be polymerized preferably consists of ≧95 and ≦99.9% by weight and particularly preferably ≧97 and ≦99.5% by weight of monomers A and ≧0.1 and ≦5% by weight and particularly preferably ≧0.5 and ≦3% by weight of epoxide monomers.

What is important is that, according to the invention, the epoxide monomers are used as a monomer mixture with the monomers A. However, it is also possible to meter the epoxide monomers into the aqueous polymerization medium separately and simultaneously with the monomers A. The epoxide monomers can be metered into the polymerization medium batchwise in one or more portions or continuously at constant or varying flow rates. As a rule, the epoxide monomers are, however, fed to the polymerization medium together with the monomers A as a monomer mixture.

Advantageously, the monomer mixture to be polymerized is chosen so that the polymer obtained therefrom has a glass transition temperature of ≦100° C., preferably ≦60° C. or ≦40° C., in particular ≦30° C. or ≦20° C. and frequently ≧−60° C. or ≧−40° C. and often ≧−30° C. and hence the aqueous composite-particle dispersions—optionally in the presence of customary film formation assistants—can be converted in a simple manner into the polymer films comprising the finely divided inorganic solids (composite films).

For the preparation of the aqueous composite-particle dispersion which can be used according to the invention by free radical polymerization, suitable free radical polymerization initiators are all those which are capable of initiating a free radical aqueous emulsion polymerization. These can in principle be both peroxides and azo compounds. Of course, redox initiator systems are also suitable. Peroxides used can in principle be inorganic peroxides, such as hydrogen peroxide or peroxodisulfates, such as the mono- or di-alkali metal or ammonium salts of peroxodisulfuric acid, such as, for example, the mono- and disodium, mono- and dipotassium or ammonium salts thereof, or organic peroxides, such as alkyl hydroperoxides, for example tert-butyl, p-menthyl, or cumyl hydroperoxide, and dialkyl or diaryl peroxides, such as di-tert-butyl or dicumyl peroxide. Essentially 2,2′-azobis(isobutyronitrile), 2,2″-azobis(2,4-dimethylvaleronitrile) and 2,2′-azobis(amidinopropyl) dihydrochloride (AIBA, corresponds to V-50 from Wako Chemicals) are used as the azo compound. Essentially the abovementioned peroxides are suitable as oxidizing agents for redox initiator systems. Sulfur compounds having a low oxidation state, such as alkali metal sulfites, for example potassium and/or sodium sulfite, alkali metal hydrogen sulfites, for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, especially potassium and/or sodium salts or aliphatic sulfinic acids, and alkali metal hydrogen sulfides, such as, for example, potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides such as sorbose, glucose, fructose and/or dihydroxyacetone, may be used as corresponding reducing agents. As a rule, the amount of the free radical polymerization initiator used is from 0.1 to 5% by weight, based on the total amount of the monomer mixture.

The entire range from 0 to 170° C. is suitable as a reaction temperature for the free radical aqueous polymerization reaction in the presence of the finely divided inorganic solid. As a rule, temperatures of from 50 to 120° C., frequently from 60 to 110° C. and often from ≧70 to 100° C. are used. The free radical aqueous emulsion polymerization can be carried out at a pressure less than, equal to or greater than 1 bar (absolute), it being possible for the polymerization temperature to exceed 100° C. and to be up to 170° C. Preferably, readily volatile monomers, such as ethylene, butadiene or vinyl chloride are polymerized under superatmospheric pressure. The pressure may be 1.2, 1.5, 2, 5, 10 or 15 bar or may assume even higher values. If emulsion polymerizations are carried out under reduced pressure, pressures of 950 mbar, frequently of 900 mbar and often of 850 mbar (absolute) are established. Advantageously, the free radical aqueous emulsion polymerization is carried out at 1 atm (absolute) under an inert gas atmosphere, such as, for example, under nitrogen or argon.

The aqueous reaction medium can in principle also comprise minor amounts of water-soluble organic solvents, such as, for example, methanol, ethanol, isopropanol, butanols, pentanols, but also acetone, etc. However, the polymerization reaction is preferably effected in the absence of such solvents.

In addition to the abovementioned components, free radical chain transfer compounds can optionally also be used in the processes for the preparation of the aqueous composite-particle dispersion in order to reduce or to control the molecular weight of the polymers obtainable by the polymerization. Substantially aliphatic and/or araliphatic halogen compounds, such as, for example, n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride and benzyl bromide, organic thio compounds, such as primary, secondary or tertiary aliphatic thiols, such as, for example, ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as, for example, 2-hydroxyethanethiol, aromatic thiols, such as benzenethiol, or ortho-, meta-, or para-methylbenzenethiol, and all further sulfur compounds described in Polymer Handbook 3^{rd} edition, 1989, J. Brandrup and E. H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes having non-conjugated double bonds, such as divinylmethane or vinylcyclohexane, or hydrocarbons having readily abstractable hydrogen atoms, such as, for example, toluene, are used. However, it is also possible to use mixtures of abovementioned free radical chain transfer compounds which do not interfere. The optionally used total amount of the free radical chain transfer compounds is as a rule ≦5% by weight, often ≦3% by weight and frequently ≦1% by weight, based on the total amount of the monomers to be polymerized.

The aqueous composite-particle dispersions obtainable by the process according to the invention usually have a total solids content of from 1 to 70% by weight, frequently from 5 to 65% by weight and often from 10 to 60% by weight.

The composite particles obtainable by the various processes, in particular according to the process disclosed in WO 03000760, have as a rule median particle diameter in the range of ≧10 nm and ≦1000 nm, frequently in the range of ≧50 nm and ≦400 nm and often in the range of ≧50 nm and ≦200 nm. The determination of the median composite particle diameter is also effected by the analytical ultracentrifuge method (cf. in this context S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). The stated values correspond to the so-called dm values. Those composite-particle dispersions whose composite particles have a median particle diameter of ≧50 nm and ≦300 nm, preferably ≦200 nm and in particular ≦150 nm are advantageous for use in elastic coatings.

The composite particles obtainable by the various processes may have different structures. The composite particles may comprise one or more of the finely divided solid particles. The finely divided solid particles may be completely surrounded by the polymer matrix. However, it is also possible for a part of the finely divided solid particles to be surrounded by the polymer matrix while another part is arranged on the surface of the polymer matrix. It is of course also possible for a major part of the finely divided solid particles to be bound on the surface of the polymer matrix.

Usually, the composite particles obtainable by the various processes have a content of finely divided inorganic solid of ≧10% by weight, preferably ≧15% by weight and particularly preferably ≧20% by weight, ≧25% by weight or ≧30% by weight, based in each case on the composite particles (corresponding to the sum of amount of polymer and amount of solid particles). Those aqueous composite-particle dispersions whose composite particles have a content of finely divided inorganic solid in the range of ≧10 and ≦60% by weight and particularly advantageously of ≧25 and ≦50% by weight are advantageously used according to the invention.

The abovementioned aqueous composite-particle dispersions are advantageously suitable as binders in elastic coating compositions.

Elastic coating compositions according to the invention accordingly comprise an aqueous composite-particle dispersion, comprising preparing the aqueous composite-particle dispersion by dispersely distributing ethylenically unsaturated monomers in an aqueous medium and carrying out polymerization by means of at least one free-radical polymerization initiator in the presence of at least one dispersely distributed, finely divided inorganic solid having an average particle diameter ≦100 nm and at least one dispersant by the method of free-radically aqueous emulsion polymerization, and using as ethylenically unsaturated monomers a monomer mixture which comprises ethylenically unsaturated monomers A and optionally 0% to ≦10% by weight of at least one ethylenically unsaturated monomer B containing an epoxide group (epoxide monomer).

For the purposes of this specification, elastic coating compositions shall comprehend all water-based formulations which comprise the composite-particle dispersion as binder.

Elastic coating compositions are intended to protect buildings reliably against moisture and other weathering effects. They are used, accordingly, in paints, such as in exterior architectural paints, for example.

The present invention accordingly further provides paints, and exterior architectural paints, comprising the elastic coating materials according to the invention.

The paints according to the invention are prepared in a known way by blending of the components in mixing apparatus customary for this purpose. It has been found appropriate to prepare an aqueous paste or dispersion from the pigments, water, and any auxiliaries, and only then to mix the polymeric binder—that is, in general, the aqueous polymer dispersion—with the pigment paste or pigment dispersion.

An elastic coating composition according to the invention comprises in the wet state
i. 10% to 98%, preferably 25% to 80%, more preferably 35% to 70% by weight of aqueous composite-particle dispersion,
ii. 0% to 60%, preferably 1% to 50%, more preferably 5% to 30% by weight of one or more inorganic fillers,
iii. 0% to 5%, preferably 0.01% to 3%, more preferably 0.1% to 2.5% by weight of one or more thickeners,
iv. 0% to 5%, preferably 1% to 3%, more preferably 0% to 1% by weight of one or more pigments, and
v. 0% to 20%, preferably 0% to 10%, more preferably 0% to 5% by weight each of further auxiliaries, such as biocides, pigment dispersants, film-forming assistants, and defoamers, for example.

Examples of suitable inorganic fillers (ii) include filler particles of andalusite, silimanite, kyanite, mullite, pyrophylite, omogolite or allophane. Additionally suitable are compounds based on sodium aluminates, silicates, such as aluminum silicates, calcium silicates or silicas (Aerosil). Likewise suitable are minerals such as siliceous earth, calcium sulfate (gypsum), which does not originate from flue-gas desulfurization plants, in the form of anhydrite, hemihydrate or dihydrate, finely ground quartz, silica gel, precipitated or natural barium sulfate, titanium dioxide, zeolites, leucite, potash feldspar, biotite, the group of the soro-, cyclo-, ino-, phyllo-, and -tectosilicates, the group of the low-solubility sulfates, such as gypsum, anhydrite or heavy spar, and also calcium minerals, such as calcite or chalk (CaCO₃).

The stated inorganic materials may be used individually or else in a mixture. Further suitable materials are precipitated or natural kaolin, talc, magnesium hydroxide or aluminum hydroxide (for setting the fire class), zinc oxide, and zirconium salts. Through addition of lightweight fillers—hollow ceramic microbeads, hollow glass beads, foam glass beads or other lightweight fillers, of the kind produced by Omega-Minerals, for example, it is possible to influence parameters such as dimensional stability and density.

Preferred inorganic fillers are the Omyacarb® products from Omya and the Finntalc® products from Mondo Minerals, the Celite® and Optimat™ products from World Minerals, the Aerosil® products from Evonik Industries AG, the Kronos® products from Kronos, the Tiona® products from Millenium, the TIOXIDE® products from Huntsman, and Ti-Pure® products from Du-Pont de Nemours.

The thickeners iii. are generally compounds of high molecular mass which either absorb water and, in so doing, swell, or form intermolecular lattice structures. The organic thickeners ultimately undergo transition to a viscous true or colloidal solution.

Use may also be made of thickeners based on acrylic acid and acrylamide (for example, Collacral® HP), carboxyl-containing acrylic ester copolymers such as Latekoll® D, PU thickeners (for example, Collacral® PU 75), celluloses and their derivatives, and also natural thickeners, such as bentonites, alginates or starch, for example.

The thickeners (iii.) are used in amounts of 0% to 5% by weight, preferably 0.1% to 2.5% by weight.

The purpose of the pigments (iv.) is to color the elastic coating compositions. This is done using organic pigments and/or inorganic pigments such as iron oxides. The pigments are used in amounts of 0% to 5% by weight, preferably 0% to 1% by weight. In summary, the elastic coating composition substantially comprises an aqueous composite-particle dispersion. Further auxiliaries v. may be added to the aqueous dispersion in a simple way.

The further auxiliaries (v.) include, for example, preservatives for preventing fungal and bacterial infestation, solvents for influencing the open time and the mechanical properties, such as butylglycol, for example, dispersing aids for improving the wetting behavior, an example being Pigment Dispersant (Pigmentverteiler®) NL (BASF Aktiengesellschaft, DE), emulsifiers (Emulphor® OPS 25, Lutensol® TO 89), frost preventatives (ethylene glycol, propylene glycol). Further possible auxiliaries include crosslinkers, adhesion promoters (acrylic acid, silanes, aziridines) or defoamers (Lumiten® products).

### EXAMPLES

### Example 1 (35% SiO₂, 70:30)

In a 2 l four-neck flask equipped with a reflux condenser, a thermometer, a mechanical stirrer, and a metering apparatus, at 20 to 25° C. (room temperature) and 1 bar (absolute), under a nitrogen atmosphere and with stirring (200 revolutions per minute), 429.4 g of Nyacol® 2040 and, subsequently, a mixture of 2.5 g of methacrylic acid and 12 g of a 10% strength by weight aqueous solution of sodium hydroxide were added over the course of 5 minutes. Thereafter the stirred reaction mixture was admixed over 15 minutes with 10.4 g of a 20% strength by weight aqueous solution of the nonionic surfactant Lutensol® AT 18 (brand of BASF SE, C₁₆C₁₈ fatty alcohol ethoxylate with 18 ethylene oxide units). Subsequently, over 60 minutes, 0.83 g of N-cetyl-N,N,N-trimethylammonium bromide (CTAB) in solution in 288 g of deionized water was metered into the reaction mixture. The reaction mixture was subsequently heated to a reaction temperature of 80° C.

Prepared in parallel were feed 1, a monomer mixture consisting of 93.7 g of methyl methacrylate (MMA), 218.8 g of n-butyl acrylate (n-BA), 6.5 g of glycidyl methacrylate (GMA), and 0.5 g of methacryloyloxypropyltrimethoxysilane (MEMO), and feed 2, an initiator solution consisting of 3.8 g of sodium peroxodisulfate, 11.5 g of a 10% strength by weight solution of sodium hydroxide, and 280 g of deionized water.

Subsequently, the reaction mixture, stirred at the reaction temperature, was admixed over 5 minutes via two separate feed lines with 21.1 g of feed 1 and 57.1 g of feed 2. Thereafter the reaction mixture was stirred at reaction temperature for an hour. Subsequently, the reaction mixture was admixed with 0.92 g of a 45% strength by weight aqueous solution of Dowfax® 2A1. Over the course of 2 hours, beginning simultaneously, the remainders of feed 1 and feed 2 were metered continuously into the reaction mixture. Thereafter the reaction mixture was stirred for a further hour at reaction temperature, before being cooled to room temperature.

The aqueous composite-particle dispersion thus obtained had a solids content of 35.5% by weight, based on the total weight of the aqueous composite-particle dispersion.

### Example 2 (35% SiO₂, 80:20)

Like example 1, but with modified amounts of MMA and nBA in feed 1: 62.5 g of MMA and 250.0 g of nBA.

### Results:

Solids content: 35.3%
pH=9
Film thickness: 0.50±0.01 mm
Water absorption (24 h): 5.51±0.20%
Tensile strength (N/mm2) at 23° C.: 6.50±0.17
Tensile strength at 0° C.: 9.30±1.16
Elongation at break at 23° C.: 161±13%
Elongation at break at 0° C.: 157±12%

### Example 3 (30% SiO₂, 80:20)

Like example 2, but with 341.8 g of Nyacol® 2040 diluted with 52.6 g of water in the initial charge.

Solids content: 35.2%
pH=9.0
Film thickness: 0.50±0.01 mm
Water absorption (24 h): 4.87±0.08%
Tensile strength (N/mm2) at 23° C.: 5.30±0.27
Tensile strength at 0° C.: 8.90±0.32
Elongation at break at 23° C.: 224±29%
Elongation at break at 0° C.: 224±30%

### Paint Formulation

| | |
|---|---|
| Water | 82.0 |
| Acticid ® MBS (Thor GmbH) | 2.0 |
| Collacral ® DS 6256 (BASF SE) | 2.5 |
| Ammonia (conc.) | 0.5 |
| AMP90 ® (Angus) | 8.0 |
| Pigmentverteiler ® MD20 (BASF SE) | 10.0 |
| Agitan ® E 255 (Münzing Chemie GmbH) | 2.0 |
| Kronos ® 2190 (Kronos) | 120.0 |
| Omyacarb ® 5 GU (Omya) | 30-60 |
| Byk ® 022 (Byk) | 1.0 |
| Acticid ® MKA (Thor GmbH) | 5.0 |
| Collacral ® LR 8990, 40% (BASF SE) | 20.0 |
| Nanocomposite dispersion (35%) | 650-680 |
| Water | 100-150 |

Paint Formulation with the Dispersion from Example 2

### SC=38.0

Film thickness: 0.36±0.00 mm
Water absorption (24 h): 13.4±0.1%
Tensile strength (N/mm2) at 23° C.: 3.30±0.03
Tensile strength at 0° C.: 5.20±0.21
Tensile strength at −10° C.: 9.6±0.27
Elongation at break at 23° C.: 84±5%
Elongation at break at 0° C.: 116±12%
Elongation at break at −10° C.: 52±9%
Water vapor permeability: Sd value=0.2
Paint Formulation with the Dispersion from Example 3

### SC=41.7

Film thickness: 0.38±0.00 mm
Water absorption (24 h): 13.7±0.21%
Tensile strength (N/mm2) at 23° C.: 2.70±0.04
Tensile strength at 0° C.: 4.70±0.33
Tensile strength at −10° C.: 8.0±0.15
Elongation at break at 23° C.: 109±6%
Elongation at break at 0° C.: 194±9%
Elongation at break at −10° C.: 86±4%
Water vapor permeability: Sd value=0.3

The pH was determined in accordance with DIN 53785. The instrument was a pH meter from Methrom, a Titroprocessor 682. Approximately 50 ml of the sample are placed in a 100 ml glass beaker. The sample is subsequently conditioned to 23±1° C. in a thermostat. The glass electrode is best stored in 3-molar KCl solution. Prior to measurement, it is rinsed a number of times with the polymer dispersion and then immersed into the sample. When the position of the pointer on the display of the instrument remains constant, the pH is read off.

Three determinations are carried out, each with new samples of the dispersion to be measured.

The tensile strength and elongation at break were determined in accordance with DIN 53455 and DIN 53504. The tensile strength [N/mm2] is the maximum tensile force [N] relative to the sample cross section [mm2] at the beginning of the test; the breaking force [N] is the tensile stress at the moment of breaking. The elongation at break vR [%] is the maximum elongation L [mm], relative to the original length L0 [mm] of the sample. The tensile test is used to assess the mechanical behavior of dispersion films under stress for elongation. These values, particularly when measured at different temperatures, allow conclusions to be drawn, for example, concerning the crack-bridging properties of paints produced using these dispersions. From the liquid specimen, a film with a thickness of approximately 500 μm is produced by casting in film-casting plates (material: Teflon, Lupolen). The film thickness is verified with an instrument from Mitutuyo, Art No. 7305, accuracy 0.01 mm. From these films, at least 5 sample rods per test temperature are punched (punching iron for S2 standard test rod in accordance with DIN 53504 (dumb bell format, 70 mm long, 4 mm wide)) and their average film thickness is measured. For the width of the sample, the dimension of the punching blade (4 mm) is assumed. These sample rods were free from contraction cracks, inward cracks, notches, blisters or other defects. The samples are stored for 28 days at 23° C., 0° C., and −10° C. and 50% relative humidity. The samples are then clamped into a tensile testing machine with a preselectable tension rate, a force transducer, and a means for measuring change in length, from Zwick with a clamped-in length of 40 mm. The sample rods are clamped into the clamps of the tensile testing machine and then stretched to breaking point at a pulling speed of 200 mm/minute.

The water vapor permeability was determined in accordance with prEN 1062-2 and ISO DIS 7783. The water vapor permeability (WVP) is the measure of the amount of water vapor [g] diffusing per day [24 h] through a sample area of 1 m².

$$W V P = \frac{Δ m}{A \cdot Δ t} \qquad [ \frac{g}{{m}^{2} \cdot d} ]$$

The water vapor permeability WVP is also referred to as water vapor diffusion flow density i, but using different units of mass and time:

$$I = \frac{Δ m}{A \cdot Δ t} = \frac{W V P}{24000} \qquad [ \frac{kg}{{m}^{2} \cdot h} ]$$

In accordance with Fick's 1^{st} law, the water vapor diffusion flow density i is used to calculate the water vapor diffusion coefficient δ.

This is a measure of the mass of water vapor which diffuses through the sample with the thickness s under the action of the water vapor partial pressure gradient, relative to the area and the time.

$$\begin{matrix}δ = \frac{i \cdot s}{{p}_{1} - {p}_{2}} & [ \frac{kg}{m \cdot h \cdot Pa} ]\end{matrix} \qquad [ 1 ]$$

The reciprocal of the diffusion coefficient δ is referred to as the diffusion transmission resistance. The diffusion resistance number δ is calculated as a ratio of the transmission resistance of the sample and of air. It indicates how many times greater the diffusion transmission resistance of the sample is than that of a resting layer of air of the same thickness and same temperature.

$$μ = \frac{1 / δ}{1 / {δ}_{L}} = \frac{{δ}_{L}}{δ} \qquad [ 2 ]$$

δ=diffusion coefficient of water vapor in the sample [kg/(m h Pa)]
δL=diffusion coefficient of water vapor in air [kg/(m h Pa)]
δL can be calculated as follows:

$${δ}_{L} = \frac{0.083}{{R}_{D} \cdot T} \cdot \frac{{p}_{0}}{p} \cdot {( \frac{T}{2 / 3} )}^{1.81}$$

p=average air pressure in the test space [hPa]
p0=atmospheric pressure under standard conditions=1013.25 [hPa]
R_{D}=gas constant for water vapor=462 [Nm/kg·K]
T=test temperature [K]

The water vapor diffusion-equivalent air layer thickness s_{d} [m] indicates the thickness that a resting layer of air must possess in order to have the same diffusion transmission resistance as the sample of thickness s.

S_{d}=μ·S

Insertion of equations [1] and [2] gives

$$\begin{matrix}{S}_{d} = \frac{{δ}_{L}}{δ} \cdot S \\ = {δ}_{L} \cdot \frac{24000 \cdot ( {p}_{1} - {p}_{2} )}{W V P} \\ = \frac{K}{W V P}\end{matrix} \qquad [ 3 ]$$

p1=water vapor partial pressure over the sample [Pa]
p2=water vapor partial pressure under the sample [Pa]
K=δ_{L} 24 000 (p₁−p₂)

This test method describes what is called the cup method, whereby the water vapor permeability is determined gravimetrically. For this purpose, in a cup which is sealed with the sample, a defined water vapor partial pressure p1 is set, and storage takes place in a space having a different water vapor partial pressure p2. This was done using the following apparatus: analytical balance with a weighing range of 400 g, accuracy 1 mg, a measuring cell, a casting apparatus, and a controlled-climate space of 23±1° C., 50±2.5% relative humidity. At least 3 parallel samples of each coating were tested. The coating was applied to a substrate. The substrate is a glass frit, type P 16 according to ISO 4793, corresponding to Schott: porosity 4. The diameter is 90 mm, the thickness is 7.5 mm, and the total test area is 50 cm². The samples were stored for 28 days under standard conditions (23° C., 50% relative humidity). For a relative humidity of 93% at 23° C., the measuring cell is filled to a level of approximately 20 mm with a saturated ammonium dihydrogen phosphate solution (with undissolved salt as a sediment). The coated frit is cemented to the measuring cell in a gastight bond by casting with a mixture, at a temperature of approximately 70° C., of 80 parts by mass of 50-55° C. paraffin and 20 parts by mass of Oppanol® B 15, using the casting apparatus. The coating faces the 50% relative humidity side. After a conditioning time of at least 24 hours under the test conditions (50% relative humidity and 23° C.), the changes in mass of the measuring cells thus prepared are recorded. For this purpose, the sample is weighed at intervals of 24 hours (m1 to mi). The diffusion-equivalent air layer thickness sd [m] is calculated from the water vapor permeability WVP (equation [3]).

$${S}_{d} = \frac{K}{W V P}$$

Since, with coatings on substrates, the measured s_{d} value still includes the contribution made by the substrate, it is necessary, in order to calculate the actual water vapor diffusion-equivalent air layer thickness s_{d}, to subtract this contribution made by the substrate (blank sample).

S_{d}(coating)=S_{d}(sample)−S_{d}(substrate)

The water absorption of the films was measured in accordance with DIN 53495. The water absorption W is the amount of water taken up by a polymer film after 24 hours of water storage. The reporting of the water absorption in % relates to the mass of the film at the beginning of measurement. For determining the water absorption W, two samples are taken from the water after 24 hours and freed from adhering water between two nonlimiting filter papers or corresponding cloths. The samples are weighed to an accuracy of 1 mg (m₁).

The water absorption is calculated as follows:

### Water Absorption

$${W}_{24 h} = \frac{{m}_{1} - {m}_{0}}{{m}_{0}} \cdot 100 [ \% ]$$

1. A method of binding an elastic coating to a surface, the method comprising:
combining an aqueous dispersion of particles comprising polymer and finely divided inorganic solid, in the form of an aqueous composite-particle dispersion with at least one component of an elastic coating formulation, to obtain the elastic coating formulation; and
applying the elastic coating formulation to the surface and binding the elastic coating to the surface.

2. The method of claim 1, further comprising, before the combining:
preparing the aqueous composite-particle dispersion by dispersely distributing at least one ethylenically unsaturated monomer in an aqueous medium; and
polymerizing the at least one monomer with at least one free-radical polymerization initiator in the presence of at least one dispersely distributed, finely divided inorganic solid having an average particle diameter ≦100 nm and at least one dispersant, by free-radically aqueous emulsion polymerization,
wherein the at least one ethylenically unsaturated monomer is a monomer mixture which comprises at least one ethylenically unsaturated monomer A and, optionally, 0% to ≦10% by weight of at least one ethylenically unsaturated monomer B comprising an epoxide group.

3. The method of claim 1, wherein the elastic coating formulation is a paint, and the aqueous composite-particle dispersion binds the paint to the surface.

4. The method of claim 1, wherein the surface is an architectural exterior.

5. The method of claim 2, wherein the composite-particle dispersion comprises 0.5% to 3% by weight of the at least one monomer V.

6. The method of claim 2, wherein a composition of the at least one monomer A is selected such that polymerization of the at least one monomer A alone would result in a polymer with a glass transition temperature ≦100° C.

7. The method of claim 2, wherein the monomer mixture to be polymerized comprises ≧95% and ≦99.9% by weight of the at least one monomer A and ≧0.1% and ≦5% by weight of the at least one monomer B.

8. The method of claim 2, wherein the monomer mixture to be polymerized is selected such that the polymer obtained therefrom has a glass transition temperature ≦100° C.

9. A paint, bound to the surface by the method of claim 1.

10. The paint of claim 9, in the form of an exterior architectural paint.

11. An elastic coating material, comprising, in a wet state:
i. 10% to 98% by weight of an aqueous composite-particle dispersion;
ii. 0% to 60% by weight of at least one inorganic filler;
iii. 0% to 5% by weight of at least one thickeners;
iv. 0% to 5% by weight of at least one pigment; and
v. 0% to 20% by weight of at least one further auxiliary.

12. The method of claim 3, wherein the composite-particle dispersion comprises 0.5% to 3% by weight of the at least one monomer B.

13. The method of claim 4, wherein the composite-particle dispersion comprises 0.5% to 3% by weight of the at least one monomer B.

14. The method of claim 3, wherein a composition of the at least one monomer A is selected such that polymerization of the at least one monomer A alone would result in a polymer with a glass transition temperature ≦100° C.

15. The method of claim 4, wherein a composition of the at least one monomer A is selected such that polymerization of the at least one monomer A alone would result in a polymer with a glass transition temperature ≦100° C.

16. The method of claim 5, wherein a composition of the at least one monomer A is selected such that polymerization of the at least one monomer A alone would result in a polymer with a glass transition temperature ≦100° C.

17. The method of claim 3, wherein the monomer mixture to be polymerized comprises ≧95% and ≦99.9% by weight of the at least one monomer A and ≧0.1% and ≦5% by weight of the at least one monomer B.

18. The method of claim 4, wherein the monomer mixture to be polymerized comprises ≧95% and ≦99.9% by weight of the at least one monomer A and ≧0.1% and 5% by weight of the at least one monomer B.

19. The method of claim 5, wherein the monomer mixture to be polymerized comprises ≧95% and ≦99.9% by weight of the at least one monomer A and ≧0.1% and ≦5% by weight of the at least one monomer B.

20. A method of binding the elastic coating material of claim 11 to a surface, the method comprising:
applying the elastic coating material to the surface and allowing it to dry.
